(19) United States
(12) Patent Application Publication
(10) Pub. No.: US 2004/0128211 A1
(43) Pub. Date: Jul. 1, 2004

(54) Purchase management system and method

(76) Inventor: Min Fun Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/404,521

(22) Filed: Mar. 31, 2003

(30) Foreign Application Priority Data
Dec. 27, 2002 (TW) 91137609

(51) Int. Cl. G06F 17/60

(52) U.S. Cl. 705/27

(57) ABSTRACT

A purchase management system includes a local database server (15), a plurality of remote database servers (16), an application server (12), and a plurality of client computers (10) connected to the application server through a network (11). The application server includes a purchase requisition management module (122) for generating purchase requisition bills, and modifying or deleting purchase requisition bills; a purchase order management module (123) for generating purchase orders, modifying or deleting purchase orders, and sending purchase orders to corresponding suppliers; a price inquiry management module (124) for determining suppliers according to price inquiry records, price negotiation records, and price comparison records; and a checking and approval management module (125) for examining and approving purchase requisition bills and purchase orders, and checking material delivered by suppliers. A related method is also disclosed.

### BACKGROUND OF THE INVENTION

1. Field of the Invention

The present invention relates to purchase management systems and methods, and particularly to a purchase management system and method that can proceed with operations of price inquiry, price negotiation, and price comparison in conjunction with an external network. This application relates to a contemporaneously filed application having the same applicant, the same assignee and the same title with the invention.

2. Background of the Invention

Purchase management implements and controls purchase procedures of a company, and manages suppliers of the company systematically. Efficient purchase management can make suppliers serve the company better, and promote cooperation between the company and its suppliers. Major objectives of purchase management are to determine reasonable ordering quantities, select excellent suppliers, and help the company maintain optimal stock levels.

Traditional purchase methods generally depend on human effort to carry out purchasing procedures. For example, a company may distribute purchase information through newspapers and magazines, and may communicate with its suppliers by ordinary mail or telephone. Labor-intensive work is slow and can be unduly expensive. In addition, it is relatively difficult for supervisors to monitor purchasing procedures that are conducted manually. As a result, the likelihood of errors going undetected is relatively high, which detracts from the reliability of such procedures.

With the recent rapid development of computer science and information technology, electronic purchasing and online purchasing are gradually replacing more traditional labor-intensive purchasing procedures. Electronic and online purchasing have considerable advantages. For example, a purchasing company releases purchase information via an external electronic communications network. Manufacturers then access the information, and bid online for the right to be the company's supplier. In another example, a purchasing company and its suppliers set up electronic information systems linked to each other by an external network such as the Internet. The purchasing company can inquire about prices of material and send purchase orders to suppliers through the external network. The suppliers provide quotations and delivery status information to the purchasing company. In these ways, online purchasing simplifies traditional procedures, improves efficiency, and reduces costs.

Systems and methods for purchasing material with the assistance of computer science and information technology are disclosed in publications such as U.S. Published patent application Ser. No. 2,002,143,692 published on Oct. 3, 2002 and entitled “Fully Automated, Requisition-Driven, . . . Centralized E-Procurement System . . . J.I.T. . . . ” This patent application provides a system for selecting suppliers by way of bidding online. The main functions of the system include handling and pooling of requisition bills; order formulation, processing and tracking; consolidated, distributed, and other shipping arrangements; procurement accounting and payment authorization; supplier-relations administration; centralized procurement catalog management; procurement data analysis and report and alert generation; and procurement needs analysis.

This patent application discloses an art of handling requisition bills and purchase orders, and managing relations with suppliers. However, the patent application does not deal with means for checking and approving purchase requisition bills and purchase orders online, nor for determining suppliers through operations of price inquiry, price negotiation, and price comparison. Thus, a system and method for purchasing material online that successfully addresses the above-mentioned shortcomings is desired.

### SUMMARY OF THE INVENTION

Accordingly, a main objective of the present invention is to provide a purchase management system and method that simplifies purchase procedures, whereby users can determine desired suppliers according to price inquiry records, price negotiation records, and price comparison records.

Another objective of the present invention is to provide a purchase management system and method, whereby users can check and approve purchase requisition bills and purchase orders online.

To achieve the above objectives, a purchase management system in accordance with a preferred embodiment of the present invention comprises: a local database server comprising a local database for storing data in purchase requisition bills and purchase orders, price inquiry records, quotations, price negotiation records, price comparison records, and information on suppliers; a plurality of remote database servers, each remote database server comprising a supplier database for storing information of a corresponding supplier; an application server; and a plurality of client computers connected to the application server through a network. The application server comprises an authorization control module for defining operational rights and scope for each of users of the system; a data maintenance module for adding, modifying, deleting and searching information in the local database server; a purchase requisition management module for generating purchase requisition bills, and modifying or deleting purchase requisition bills; a purchase order management module for generating purchase orders, modifying or deleting purchase orders, and sending purchase orders to suppliers; a price inquiry management module for determining desired suppliers according to records on price inquiries, quotations and price negotiations; and a checking and approval management module for examining and approving purchase requisition bills and purchase orders, and checking material delivered by suppliers. The price inquiry management module further comprises a price inquiry bill sending sub-module, a quotation receiving sub-module, a price negotiation sub-module, and a price comparison sub-module. The application server is connected to the remote database servers via an external network, through which the application server sends price inquiry bills and purchase orders to the remote database servers, and accepts quotations from the remote database servers.

Further, the present invention provides a purchase management method that can be implemented using said purchase management system. The method comprises the steps of: (a) generating purchase requisition bills automatically according to purchase requisition information from internal departments of an organization; (b) checking the purchase requisition bills; (c) sending price inquiry bills to suppliers via an external network; (d) receiving quotations sent by suppliers via the external network; (e) determining whether to negotiate price or not based on the received quotations; wherein if price negotiation is required, proceeding to step (f), and if price negotiation is not required, proceeding directly to step (g); (f) carrying out price negotiation, and generating corresponding records; (g) carrying out price comparison, and determining one or more desired suppliers according to price inquiry records and quotations, and price negotiation records if applicable; (h) generating purchase orders according to the purchase requisition bills, and checking the purchasing orders; (i) sending the purchase orders to one or more suppliers; (j) checking material delivered by the one or more suppliers according to the purchase orders and quality reports on the material, accepting the material if delivery bills coincide with the purchase orders, and if the quality of the material is satisfactory, or returning the material to the one or more suppliers if the delivery bills do not coincide with the purchase orders, or if the quality of the material is not satisfactory; and (k) if the material is accepted, balancing purchase accounts according to the purchase orders, and generating balancing records.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware configuration of a purchase management system in accordance with a preferred embodiment of the present invention, the system including an application server, a plurality of client computers and a plurality of remote database servers;

FIG. 2 is a block diagram of main function units of the purchase management system of FIG. 1, but showing only one of the client computers and one of the remote database servers;

FIG. 3 is a schematic diagram of infrastructure of a price inquiry management module of the application server of FIG. 2;

FIG. 4 is a flowchart of a preferred method for implementing the purchase management system of the present invention; and

FIG. 5 is a flowchart of details of two steps of FIG. 4; namely price inquiry, price negotiation and price comparison, and determining desired suppliers.

### DETAILED DESCRIPTION OF THE INVENTION

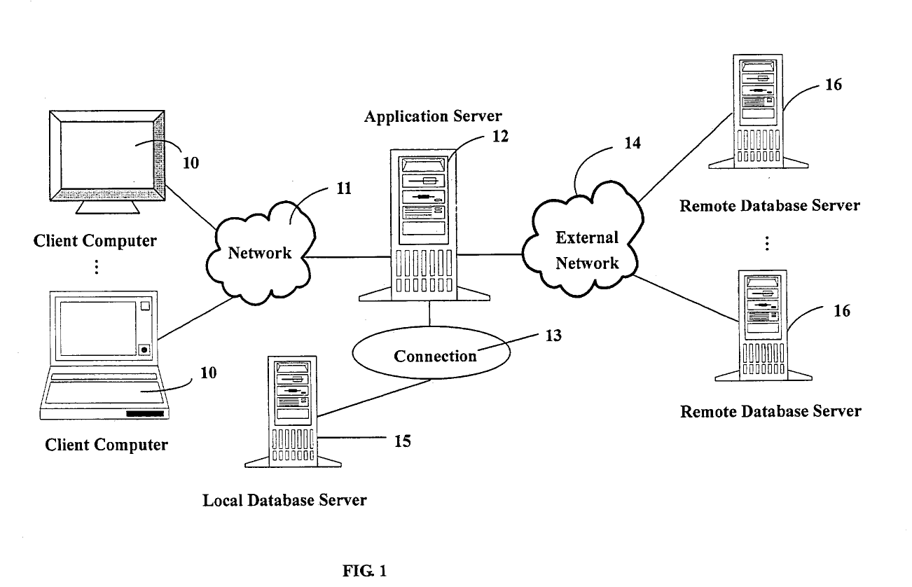

FIG. 1 is a schematic diagram of hardware configuration of a purchase management system in accordance with a preferred embodiment of the present invention. The purchase management system comprises an application server 12, a local database server 15, a plurality of remote database servers 16, and a plurality of client computers 10 connected to the application server 12 through a network 11. The network 11 can be an intranet or the Internet, through which the application server 12 can receive purchase requisition information from various departments of a company where the client computers 10 are located. The application server 12 is connected to the local database server 15 through a connection 13. The connection 13 is connectivity such as ODBC (Open Database Connectivity) or JDBC (Java Database Connectivity). Each remote database server 16 is connected to the application server 12 through an external network 14, which may for example be the Internet.

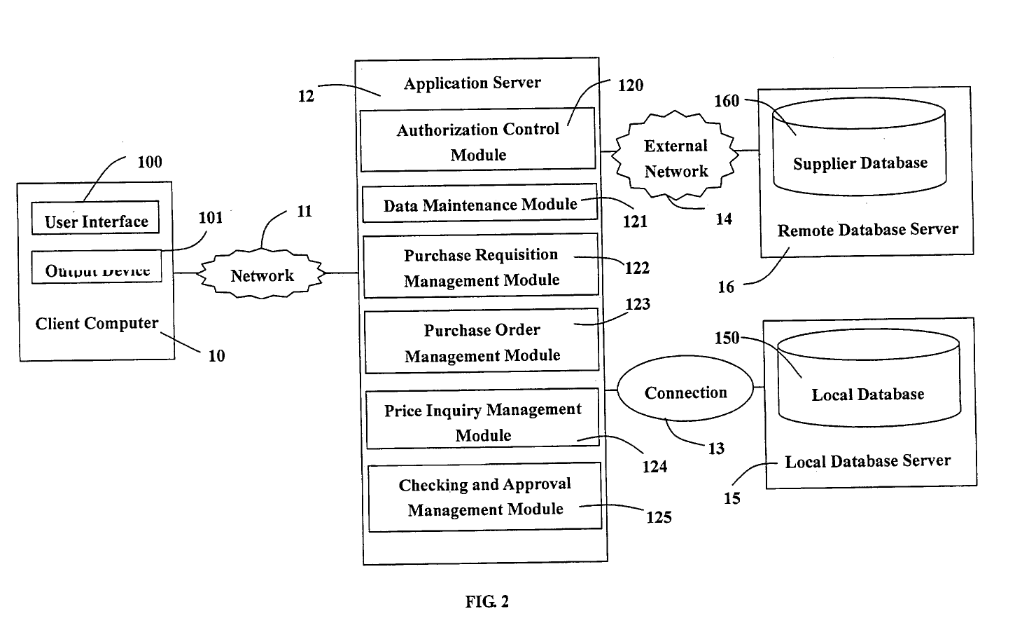

FIG. 2 is a block diagram of main function units of the purchase management system, but showing only one client computer 10 and one remote database server 16. The client computer 10 comprises a user interface 100 and an output device 101. The user interface 100 provides an interactive interface for carrying out operations such as inputting basic information and data on quotations from suppliers, and for adding, modifying, deleting or searching basic information. The output device 101 displays information including data in purchase requisition bills and in purchase orders, and basic information on suppliers. The local database server 15 comprises a local database 150 for storing data of purchase requisition bills and purchase orders, price inquiry records, quotations, price negotiation records, price comparison records, and basic information on suppliers. Each remote database server 16 comprises a supplier database 160 for a relevant supplier to store basic information.

The application server 12 comprises an authorization control module 120, a data maintenance module 121, a purchase requisition management module 122, a purchase order management module 123, a price inquiry management module 124, and a checking and approval management module 125. The authorization control module 120 defines operational rights and a scope of access for each user of the purchase management system. The data maintenance module 121 is used for adding, modifying, deleting or searching basic information. Said basic information includes data in purchase requisition bills and purchase orders, price inquiry records, price negotiation records, price comparison records, and information on suppliers. The purchase requisition management module 122 is for generating purchase requisition bills, and modifying or deleting purchase requisition bills. Basic information in a purchase requisition bill includes categories of material required, requisition quantities, due dates for delivery, and expected prices. The purchase order management module 123 is for generating purchase orders, modifying or deleting purchase orders, and sending purchase orders to corresponding suppliers. Basic information in a purchase order includes a number of the purchase order, purchase quantities, specifications of purchased material, due date for delivery, delivery destinations, unit prices and total prices, cash discounts, and other payment conditions. The price inquiry management module 124 is for obtaining quotations from suppliers, negotiating with suppliers, and comparing quotations from different suppliers to determine desired suppliers. Basic information in a quotation includes specifications of materials, purchase quantities, due dates for delivery, and delivery destinations. The checking and approval management module 124 is for examining and approving purchase requisition bills and purchase orders, and checking material delivered by suppliers.

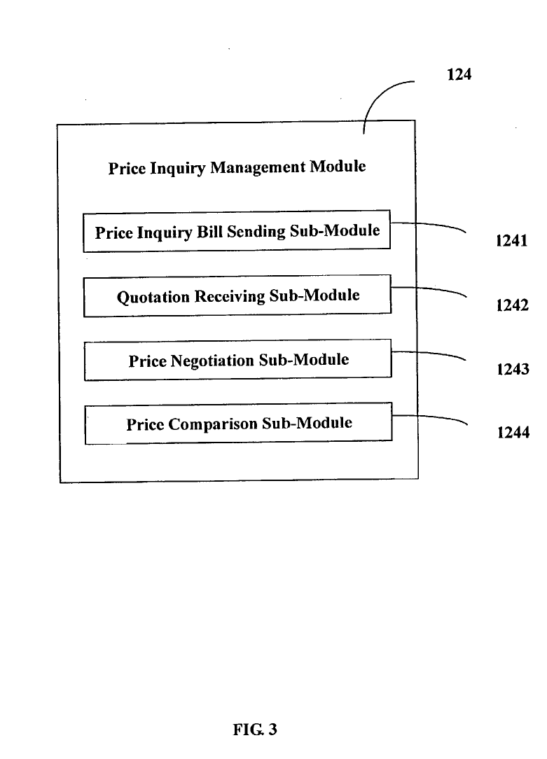

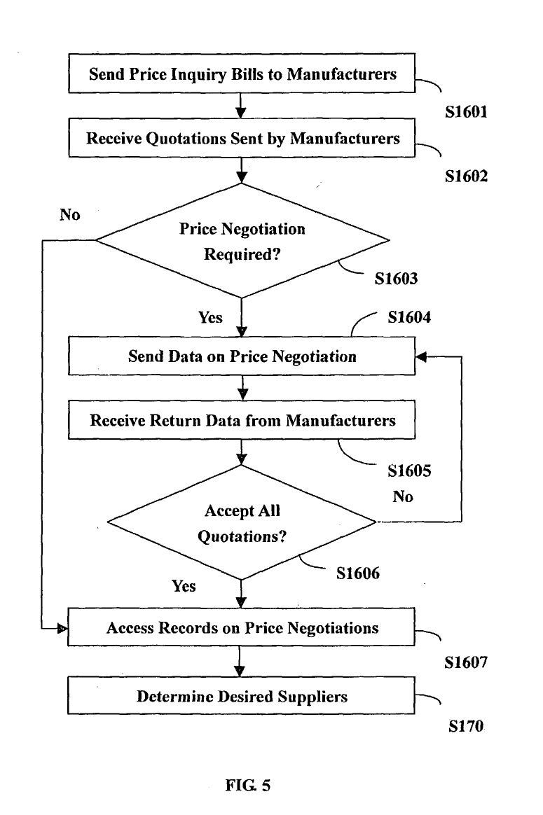

FIG. 3 is a schematic diagram of infrastructure of the price inquiry management module 124 of the application server 12. The price inquiry management module 124 comprises a price inquiry bill sending sub-module 1241 for obtaining price inquiry bills by accessing the local database 150, and for sending the price inquiry bills to suppliers via the external network 14; a quotation receiving sub-module 1242 for receiving quotations from suppliers, and for storing relevant data on the quotations in the local database 150; a price negotiation sub-module 1243 for sending data on negotiations, receiving return data on the negotiations sent by suppliers, and storing relevant data on the negotiations in the local database 150; and a price comparison sub-module 1244 for comparing results of price inquiries and price negotiations to determine desired suppliers for the purchase requisition bill, and for inputting the data on inquiries, quotations, and negotiations into data on suppliers. Functions of the above-mentioned sub-modules 1241-1244 are further detailed in the following description in relation to FIG. 5.

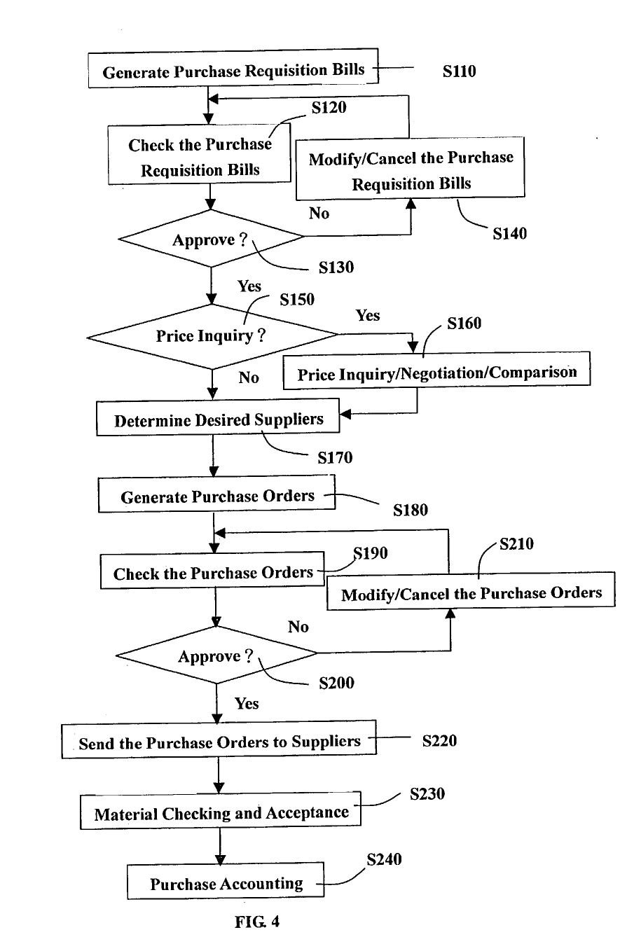

FIG. 4 is a flowchart of a preferred method for implementing the purchase management system of the present invention. In step S110, the purchase requisition management module 122 automatically generates purchase requisition bills according to purchase requisition information obtained from various departments of the company via the network 11, and stores the purchase requisition bills in the local database 150. Users can maintain the purchase requisition bills through the data maintenance module 121. For example, users can add, modify, delete or search information in the purchase requisition bills. In step S120, users who are authorized by the authorization control module 120 to check purchase requisition bills proceed to check the purchase requisition bills through the checking and approval management module 125. In step S130, a user having appropriate authority authorized by the authorization control module 120 examines the purchase requisition bills through the checking and approval management module 125. A purchase requisition bill that passes the examination is automatically tagged as having an “approved” status. Only purchase requisition bills that have been approved can be processed further. If any purchase requisition bills are not approved, in step S140, users modify or delete those purchase requisition bills through the purchase requisition management module 122. Said purchase requisition bills are generally sent back to requisitioning departments for modification or cancellation. Any modified purchase requisition bills are then re-checked according to step S120. In step S150, users decide whether to inquire about prices of material in the approved purchase requisition bills through the price inquiry management module 124. If price inquiries are not required, the procedure proceeds directly to step S170 described below. If price inquiries are required, in step S160, the price inquiry management module 124 generates price inquiry bills, and sends the price inquiry bills to corresponding suppliers through the external network 14. The suppliers store the price inquiry bills in the respective supplier databases 160, and generate quotations according to the price inquiry bills through the respective remote database servers 16. The quotations are sent to the application server 12. Then, the price inquiry management module 124 implements operations of price negotiation and price comparison according to the quotations, whereupon the procedure proceeds to step S170. In step S170, users determine desired suppliers via the price inquiry management module 124. In step S180, the purchase order management module 123 generates purchase orders according to the purchase requisition bills. In step S190, users who are authorized by the authorization control module 120 to check purchase orders proceed to check the purchase orders through the checking and approval management module 125. In step S200, a user having appropriate authority authorized by the authorization control module 120 examines the purchase orders through the checking and approval management module 125. A purchase order that passes the examination is automatically tagged as having an “approved” status. Only purchase orders that have been approved can be processed further. If any purchase orders do not pass the examination, in step S210, users modify or delete those purchase orders through the purchase order management module 123 according to a predetermined sequence of checking and approval. Any modified purchase orders are then re-checked according to step S190. In step S220, the application server 12 sends the approved purchase orders to corresponding suppliers via the external network 14. In step S230, the suppliers receive the purchase orders, generate quotations according to the purchase orders, and send the quotations to the application server 12. The quotations are stored in the local database 150. When purchased material is delivered, purchasing operators obtain delivery bills from the deliverer, and check the material via the checking and approval management module 125 according to the purchase orders and quality reports on the material. The purchasing operators accept the material if the delivery bills coincide with the purchase orders, and if the quality of the material is satisfactory. The purchasing operators return the material to the suppliers if the delivery bills do not coincide with the purchase orders, or if the quality of the material is not satisfactory. If the purchasing operators accept the material, in step S240, the purchasing operators balance purchase accounts, and store balancing records in the local database 150.

FIG. 5 is a flowchart of details of step S160 and step S170 of FIG. 4; namely price inquiry, price negotiation and price comparison; and determining desired suppliers. In step S1601, for each purchase requisition bill needing to be processed, the purchase management system generates a corresponding price inquiry bill. The price inquiry sub-module 1241 sends the price inquiry bills to respective suppliers via the external network 14. In step S1602, the quotation receiving sub-module 1242 receives quotations sent by the suppliers via the external network 14, and stores data on the quotations in the local database 150. The data on each quotation comprise a date, a condition of payment, a condition of price, a quotation number, a unit name, a unit price, a useful lifetime, a currency of payment, and an abstract. In step S1603, the purchase operators determine whether price negotiation is required, based on the received data on quotations. If price negotiation is not required, the purchase management system proceeds directly to step S1607 for an operation of price comparison, described in more detail below. If price negotiation is required, in step S1604, purchasing operators input data on negotiations, and the price negotiation sub-module 1243 sends respective data on price negotiations to corresponding suppliers via the external network 14. In step S1605, the price negotiation sub-module 1243 receives return data on price negotiations from the suppliers, and stores records on price negotiations in the local database 150. The records on price negotiations include the data on negotiations sent by the purchase management system, and the return data on negotiations sent by the suppliers. Such data comprise unit prices and currencies for payment. The first record on a negotiation is an initial quotation, and all said records are retained and not deleted. In step S1606, the purchase operators determine whether to accept any current quotation as a final quotation. If any current quotation is not accepted, the procedure returns to step S1604 described above. If all current quotations are accepted, then the operation of price comparison is commenced as follows. In step S1607, the price comparison sub-module 1244 accesses the records on price inquiries, quotations and price negotiations. In step S170, based on comparisons in said records, the price comparison sub-module 1244 determines desired suppliers, converts relevant parts of said records and price comparisons into basic data on the suppliers, and stores the basic data on the suppliers in the local database 150.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A purchase management system for determining desired suppliers according to records on price inquiries, quotations and price negotiations, the system comprising:
a local database server comprising a local database for storing data in purchase requisition bills and purchase orders, price inquiry records, quotations, price negotiation records, price comparison records, and information on suppliers;
a plurality of remote database servers, each of the remote database servers comprising a supplier database for storing information of a corresponding supplier; and
an application server comprising:
a purchase requisition management module for generating purchase requisition bills, and modifying or deleting purchase requisition bills;
a purchase order management module for generating purchase orders, modifying or deleting purchase orders, and sending purchase orders to suppliers;
a price inquiry management module for determining desired suppliers according to records on price inquiries, quotations and price negotiations; and
a checking and approval management module for examining and approving purchase requisition bills and purchase orders, and checking material delivered by suppliers;
wherein the price inquiry management module comprises:
a price inquiry bill sending sub-module for obtaining price inquiry bills from the local database, and for sending the price inquiry bills to suppliers;
a quotation receiving sub-module for receiving quotations sent by suppliers, and for storing quotations in the local database;
a price negotiation sub-module for sending data on price negotiations to corresponding suppliers, receiving return data on price negotiations sent by the suppliers, and storing records on price negotiation in the local database; and
a price comparison sub-module for comparing records on price inquiries, quotations and price negotiations, determining desired suppliers for the purchase requisition bills, and converting the records on price inquiries, quotations and price negotiations into data on the suppliers; and wherein
the application server is connected to the remote database servers via an external network, through which the application server sends price inquiry bills and purchase orders to the remote database servers, and accepts quotations from the remote database servers.

2. The system according to claim 1, further comprising a plurality of client computers connected to the application server via a network, whereby users can maintain information in the local database server.

3. The system according to claim 1, wherein the application server further comprises an authorization control module for defining operational rights and scope for each of users of the system.

4. The system according to claim 1, wherein the application server further comprises a data maintenance module for adding, modifying, deleting and searching information in the local database server.

5. A purchase management method comprising the steps of:
(a) generating purchase requisition bills automatically according to purchase requisition information received from internal departments of an organization;
(b) checking the purchase requisition bills;
(c) sending price inquiry bills to suppliers via an external network;
(d) receiving quotations sent by suppliers via the external network;
(e) determining whether to negotiate price or not based on the received quotations; wherein if price negotiation is required, proceeding to step (f), and if price negotiation is not required, proceeding directly to step (g);
(f) carrying out price negotiation, and generating corresponding records;
(g) carrying out price comparison, and determining one or more desired suppliers according to price inquiry records and quotations, and price negotiation records if applicable;
(h) generating purchase orders according to the purchase requisition bills, and checking the purchase orders;
(i) sending the purchase orders to one or more suppliers;
(j) checking material delivered by the one or more suppliers according to the purchase orders and quality reports on the material, accepting the material if delivery bills coincide with the purchase orders and if the quality of the material is satisfactory, or returning the material to the one or more suppliers if the delivery bills do not coincide with the purchase orders or if the quality of the material is not satisfactory; and
(k) if the material is accepted, balancing purchase accounts according to the purchase orders, and generating balancing records.

6. The method according to claim 5, wherein step (b) comprises the steps of:
(b1) examining the purchase requisition bills, and changing any purchase requisition bills that pass the examination to an approved status; and
(b2) modifying or deleting any purchase requisition bills that do not pass the examination.

7. The method according to claim 5, wherein step (f) comprises the steps of:
(f1) sending data on price negotiation to corresponding suppliers;
(f2) receiving return data on price negotiation sent by the suppliers; and
(f3) determining whether to accept all current negotiations, wherein if all current negotiations are accepted, proceeding to step (g), or if any one or more current negotiations are not accepted, returning to step (f1) with respect to the one or more current negotiations not accepted; and
(f4) storing price negotiation records in the local database.

8. The method according to claim 5, wherein step (g) comprises the steps of:
(g1) inquiring of the records on price inquiries, quotations and price negotiations; and
(g2) determining desired suppliers by comparing the above records, and converting the records on price inquiries, quotations and price negotiations into data on suppliers;

9. The method according to claim 5, wherein step (h) comprises the steps of:
(h1) examining the purchase orders, and changing any purchase orders that pass the examination to an approved status; and
(h2) modifying or deleting any purchase orders that do not pass the examination.

10. A purchase management method comprising steps of:
(a) generating purchase requisition bills automatically according to purchase requisition information received from internal departments of an organization;
(b) checking the purchase requisition bills;
(c) sending price inquiry bills to a plurality of available suppliers via an external network;
(d) receiving quotations sent by said suppliers via the external network;
(e) carrying out price negotiation, and generating corresponding records;
(f) carrying out price comparison, and determining one or more desired suppliers from said suppliers according to price inquiry records and quotations;
(g) generating purchase orders according to the purchase requisition bills, and checking the purchase orders;
(h) sending the purchase orders to said one or more desired suppliers via the external network;
(i) checking material delivered by the one or more desired suppliers according to the purchase orders and quality reports on the material, accepting the material if delivery bills coincide with the purchase orders and if the quality of the material is satisfactory factory; and
(j) balancing purchase accounts according to the purchase orders, and generating balancing records.
